(19) United States
(12) Patent Application Publication
(10) Pub. No.: US 2013/0100172 A1
(43) Pub. Date: Apr. 25, 2013

(54) LIQUID CRYSTAL DISPLAY DEVICE AND DRIVING METHOD THEREOF

(71) Applicants: Hung-lung Hou, Shenzhen (CN); Chengming He, Shenzhen (CN)

(72) Inventors: Hung-lung Hou, Shenzhen (CN); Chengming He, Shenzhen (CN)

(73) Assignee: SHENZHEN CHINA STAR OPTOELECTRONS TECHNOLOGY CO., LTD, Guangdong, Shenzhen (CN)

(21) Appl. No.: 13/379,796

(22) PCT Filed: Nov. 1, 2011
(86) PCT No.: PCT/CN2011/081640

§ 371 Date: Dec. 21, 2011

(30) Foreign Application Priority Data
Oct. 25, 2011 (CN) 201110327771.8

(51) Int. Cl. G09G 3/36; G09G 5/10

(52) U.S. Cl. 345/690; 345/89

(57) ABSTRACT

The present invention discloses an LCD device and a driving method of the LCD device. The LCD device comprises a plurality of scan lines, a plurality of data lines, a data driver, a scan driver, and a plurality of pixels. The pixels comprise a first pixel set and a second pixel set. The first pixel set and the second pixel set are arranged alternatively. Each of the pixels has a first display mode and a second display mode. The pixels of the first pixel set and the pixels of the second pixel set are alternatively switched between the first display mode and the second display mode. The LCD device and related driving method in the present invention is capable of improving the display quality.

### BACKGROUND OF THE INVENTION

1. Field of the Invention

The present invention relates to a liquid crystal display (LCD) device and driving method thereof.

2. Description of the Prior Art

Displays with advanced functions have become an important role of today's consuming products. LCD devices, especially which have high resolution, are widely used as the displays of TVs, mobile phones, PDAs, digital cameras, personal computers, and laptops.

Please refer to FIG. 1, which is a schematic view illustrating a conventional LCD device 10. The LCD device 10 comprises a timing controller 14, a data driver 16, a scan driver 18, and an LCD panel 20. The LCD panel 20 comprises a plurality of pixels. Each pixel comprises at least a red sub-pixel R, a green sub-pixel G, a blue sub-pixel B. Taking the LCD panel 20 having 1024*768 resolutions as an example, the LCD panel 20 comprises 1024*768*3 sub-pixels 22. The timing controller 14 generates control signals and transfers the timing-control signals to the scan driver 18. The scan driver 18 generates scan signals to the LCD panel according to the control signal. At the same time, the timing controller 14 outputs another control signal to the data driver 16 such that the data driver 16 outputs the gray scale voltage signal to the sub-pixels 22 of the LCD panel 20 according to the control signal.

In the conventional LCD device design, the scan driver 18 outputs the scan signals to the LCD panel every a fixed time interval. For the LCD panel 20 with 1024*768 resolutions and a 60 Hz frame rate, the display time of a frame is 1/60=16.67 ms. Therefore, the pulse width of the scan signal is 16.68/768=21.7 μs. The data driver 16 outputs the gray scale voltages to charge into the pixels in the said 21.7 μs such that the correct gray scale data is able to be written into the pixels.

Taking a pixel with 255 gray scales as an example, the gray scale 0 represents an ideally full black and the gray scale 255 represents an ideally full white, when the gray scale is changed from full black to gray, the gray scale value may ideally be changed from 0 to 160. In another case, when the gray scale is changed from full white to gray, the gray value may ideally be changed from 255 to 160. However, in fact, the brightness of the pixels is lower than the desired brightness due to reducing the rotating time of liquid crystal molecules in a limited rotating velocity. Therefore, when the gray scale changes from full black to gray, the gray value actually changes from 0 to 144. Furthermore, when the gray scale changes from full white to gray, the gray value may be changed from 255 to 163. From the above, it can be seen that if two adjacent pixels respectively change from full back to gray and from full white to gray, the difference of the gray scale value between them is actually about 19% such that the display quality is not good.

In order to solve the above-mentioned problem, a conventional method is black frame insertion. The black frame insertion is to insert black frame in the switching of the gray scale. For example, if the image changes from full black to gray, the actual series of images is black image, inserted black image, gray image, and inserted black image, and the corresponding gray scale values are, 0, 0, 160, and 0. Similarly, if the image changes from full white to gray, the actual series of images is white image, inserted black image, gray image, and inserted black image, and the corresponding gray values are, 255, 0, 160, and 0. Through using the above-mentioned black frame insertion, the difference between the actual gray values of adjacent pixels can be reduced to 9%. But there is still a disadvantage. The black frame insertion technique should be accomplished by doubling the frame rate. That is, in an ordinary display, the frame rate is 60 Hz, and this means switching from one frame to next frame in the 1/60 second. But in a display having black frame insertion, the frame rate is 120 Hz. This means each frame only has 1/120 second to update. The first updating operation is to show a normal image, and the second updating operation is to show the inserted black image. Although the black frame insertion can reduce the difference of the gray scale value, the charging time of the pixels is also reduced and the overall brightness is also reduced due to the inserted black frames.

### SUMMARY OF THE INVENTION

It is one of the primary objectives of the present invention to provide an LCD device and driving method to improve the display quality when the pixels are changed from different gray scales to the same gray scale.

In an exemplary embodiment, an LCD device comprises an LCD panel, scan drivers and data drivers. The LCD panel comprises a plurality of scan lines; a plurality of data lines intersecting the scan lines; and a plurality of pixels arranged in a matrix form. Each pixel including a plurality of sub-pixels, each of the sub-pixels disposed in an area defined by the scan lines and the data lines. The scan drivers apply scan pulses to the scan lines. The data drivers apply gray scale voltage signals to the data lines. The pixels are divided into a first pixel set and a second pixel set, pixels of the first pixel set and pixels of the second pixel set are arranged alternatively. In the pixels arranged in the matrix form, two adjacent pixels respectively are divided into the first pixel set and the second pixel set. Each of the pixels has a first display mode and a second display mode. In the first display mode, the data drivers apply gray scale voltage signals corresponding to a normal image to the pixels via the data lines. In the second display mode, the data drivers apply black level signals to the pixels via the data lines. The pixels of the first pixel set and the pixels of the second pixel set are alternatively switched between the first display mode and the second display mode with switching from one frame to the next frame.

Furthermore, when the scan lines in the i^{th} frame are scanned, the pixels in one of the first pixel set and the second pixel set are in the first display mode, and the pixels in the other of the first pixel set and the second pixel set are in the second display mode. when the scan lines in the (i+1)^{th} frame are scanned, the pixel set in the first display mode in the i^{th} frame is switched to the second display mode, and the pixel set in the second display mode in the i^{th} frame is switched to the first display mode, wherein i is a positive integer.

Furthermore, each of the pixels comprises at least red sub-pixels, green sub-pixels, and blue sub-pixels.

In an exemplary embodiment, an LCD device comprises an LCD panel, scan drivers and data drivers. The LCD panel comprises a plurality of scan lines; a plurality of data lines intersecting the scan lines; and a plurality of pixels arranged in a matrix form. Each pixel including a plurality of sub-pixels, each of the sub-pixels disposed in an area defined by the scan lines and the data lines. The scan drivers apply scan pulses to the scan lines. The data drivers apply gray scale voltage signals to the data lines. The pixels are divided into a first pixel set and a second pixel set, pixels of the first pixel set and pixels of the second pixel set are arranged alternatively. In the pixels arranged in the matrix form, two adjacent pixels respectively are divided into the first pixel set and the second pixel set. Each of the pixels has a first display mode and a second display mode. In the first display mode, the data drivers apply gray scale voltage signals corresponding to a normal image to the pixels via the data lines. In the second display mode, the data drivers apply specific gray scale voltage signals to the pixels via the data lines. The pixels of the first pixel set and the pixels of the second pixel set are alternatively switched between the first display mode and the second display mode with switching from one frame to the next frame.

Furthermore, when the scan lines in the i^{th} frame are scanned, the pixels in one of the first pixel set and the second pixel set are in the first display mode, and the pixels in the other of the first pixel set and the second pixel set are in the second display mode. when the scan lines in the (i+1)^{th} frame are scanned, the pixel set in the first display mode in the i^{th} frame is switched to the second display mode, and the pixel set in the second display mode in the i^{th} frame is switched to the first display mode, wherein i is a positive integer.

Furthermore, in the matrix of the pixels, the pixels in each row belong to the same pixel set, and pixels in any two adjacent row respectively belong to different pixel sets.

Furthermore, in the matrix of the pixels, the pixels in each column belong to the same pixel set, and pixels in any two adjacent columns respectively belong to different pixel sets.

Furthermore, the specific gray scale voltage signals are black level signals.

In an exemplary embodiment, a driving method of an LCD device is provided. The LCD panel comprises a plurality of scan lines; a plurality of data lines intersecting the scan lines; and a plurality of pixels arranged in a matrix form. Each pixel including a plurality of sub-pixels, each of the sub-pixels disposed in an area defined by the scan lines and the data lines. The scan drivers apply scan pulses to the scan lines. The data drivers apply gray scale voltage signals to the data lines. The pixels are divided into a first pixel set and a second pixel set, and pixels of the first pixel set and pixels of the second pixel set are arranged alternatively. The driving method comprises: (A) when the scan lines in the i^{th} frame are scanned, the data driver outputs gray scale voltage signals corresponding to a normal image to the pixels of the first pixel set via the data lines, and outputs specific gray scale voltage signals to the pixels of the second pixel set; (B) when the scan lines in the (i+1)^{th} frame are scanned, the data driver outputs specific gray scale voltage signals to the pixels of the first pixel set, and outputs gray voltage signals corresponding to a normal image to the pixels of the second pixel set; (C) repeating the step (A) and step (B), wherein i is a positive integer.

In contrast to the related art, the LCD device and related driving method can reduce the difference of luminance when switching different gray scales to same gray scale in case of remaining the frame rate unchanged. Therefore the display quality of the LCD device is improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic view illustrating a conventional LCD device .

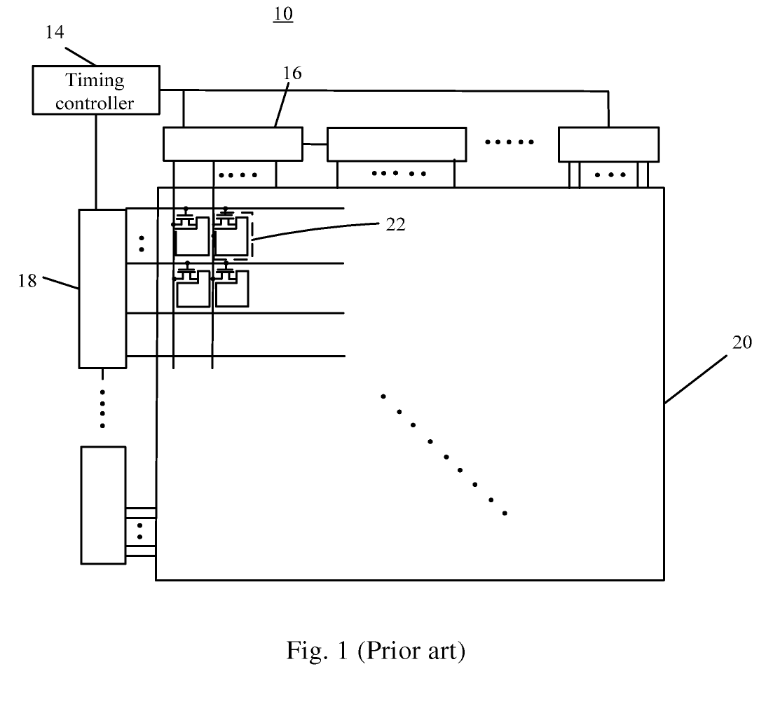

FIG. 2 is a schematic view illustrating an LCD according to a preferred embodiment of the present invention.

FIG. 3 is a schematic view illustrating an LCD panel according to a first embodiment of the present invention.

FIG. 4 is a schematic view illustrating an LCD panel according to a second embodiment of the present invention.

FIG. 5 is a schematic view illustrating an LCD panel according to a third embodiment of the present invention.

### DETAILED DESCRIPTION OF THE PREFERRED EMBODIMENT

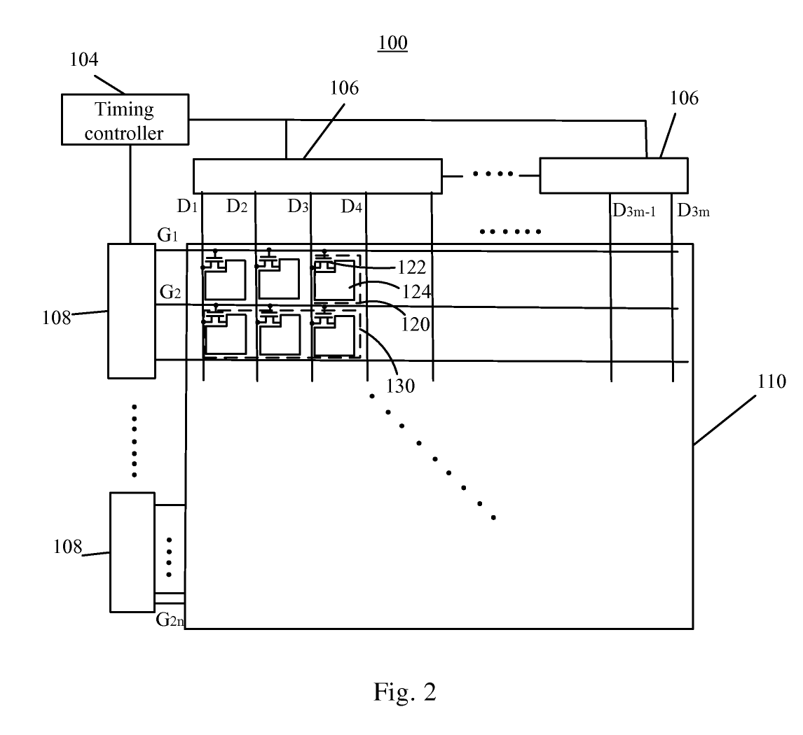

Please refer to FIG. 2, which is a schematic view illustrating an LCD device 100 according to a preferred embodiment of the present invention. The LCD device 100 can be used as a display for a personal computer or a laptop. The LCD device 100 comprises a timing controller 104, data drivers 106, scan drivers 108, and an LCD panel 110. The LCD panel comprises a plurality of scan lines G₁-G₂ₙ, a plurality of data lines D₁-D₃ₘ, and pixels 130. The pixels 130 are arranged in a matrix. Each of the pixels 130 comprises at least Red sub-pixels(R), Green sub-pixels (G), Blue sub-pixels (B) 120. The sub-pixels 120 are located in an area defined by the scan lines G₁-G₂ₙ and the data lines D₁-D₃ₘ. When the timing controller 104 generates vertical synchronization (V-sync) signals and outputs the vertical synchronization (V-sync) signals to the scan drivers 108, the scan drivers 108 sequentially output scan pulses (scan signal) to the LCD panel 110 via the scan lines G₁-G₂ₙ according to the V-sync signal. At the same time, the timing controller 104 outputs horizontal synchronization (H-sync) signals to the data drivers 106. The data drivers 106 output gray scale voltage signals to the LCD panel 110 via the data lines D₁-D₃ₘ according to the H-sync signals. Each sub-pixel 120 comprises a pixel electrode 124 and a thin film transistor (TFT) 122. The TFT comprises a gate, a source and a drain. The gate, source and drain of the TFT 122 are respectively coupled to the scan line, data line, and pixel electrode 124 of corresponding sub-pixel 120. The scan drivers 108 are used to output the scan pulses via the scan lines G₁-G₂ₙ. The data drivers 106 are used to output the gray scale voltage signal via the data lines D₁-D₃ₘ. The pixels 130 are divided into a first pixel set and a second pixel set. Pixels 130 of the first pixel set and pixels 130 of the second pixel set are arranged alternatively. Each of the pixels 130 has a first display mode and a second display mode. In the first display mode, the data drivers 106 provide gray scale voltage signals corresponding to a normal image to the pixels 130 via the data lines, and in the second display mode, the data drivers 106 provide specific gray scale voltage signals to the pixels via the data lines. In a preferred embodiment, the specific gray scale voltage signals are black voltage signals. The pixels 130 of the first pixel set and the pixels 130 of the second pixel set are switched between the first display mode and the second display mode according to switches of frames.

Specifically, when the LCD panel displays the i^{th} frame image, one of the first pixel set and the second pixel set is in the first display mode , and the other of the first pixel set and the second pixel set is in the second display mode. Besides, when the LCD panel displays the (i+1)^{th} frame image, the mode of the pixel set in the first display mode in the i^{th} frame is switched to the second display mode, and the mode of the pixel set in the second display mode in the i^{th} frame is switched to the first display mode, wherein the above-mentioned “i” represents a positive integer.

In compare to the prior art, the LCD device of the present invention reduces the difference of luminance when switching different gray scales to same gray scale in case of remaining the frame rate unchanged. Therefore the display quality of the LCD device is improved.

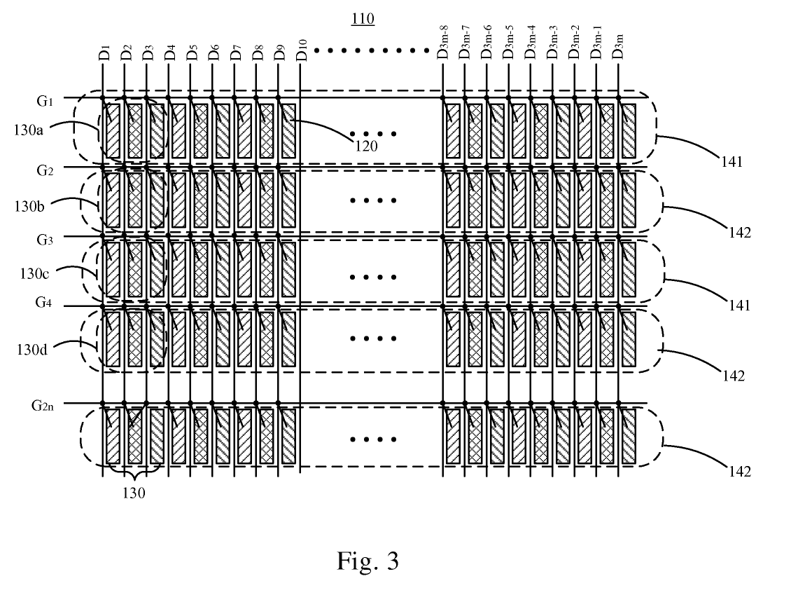

Referring to Fig.3, which is a schematic view illustrating an LCD panel according to a first embodiment of the present invention. The TFTs 122 and the pixel electrodes 124 of the sub-pixels 120 are not shown in the following figures so as to simply the drawings. The sub-pixels 120 shown in Fig.3 are respectively connected to corresponding scan lines G₁-G₂ₙ and data lines D₁-D₃ₘ. It means that the gate and the source of the TFTs 122 of the sub-pixels 120 are respectively connected to the corresponding scan lines G₁-G₂ₙ and data lines D₁ᵢ-D₃ₘ. As shown in Fig.3, the pixels of LCD panel 110 are divided into a first pixel set 141 and a second pixel set 142. The first pixel set 141 comprises a plurality of pixels 130a and 130c. The gates of the TFTs 122 of the pixels 130a and 130c are respectively coupled to odd gate lines G₁,G₃, . . . , and G₂ₙ₋₁. The second pixel set 142 comprises a plurality of pixels 130b and 130d. The gates of the TFTs 122 of the pixels 130b and 130d are respectively coupled to even gate lines G₂, G₄ . . . and G₂ₙ. In other words, pixels of the same row in the matrix belong to the same pixel set. And pixels of adjacent rows respectively belong to different pixel sets. In this embodiment, the frame rate of the LCD device 100 is 60 Hz.

When the scan driver 108 outputs scan pulses to scan the first scan line G₁ in the i^{th} frame (where i is a positive integer), the data driver 106 outputs gray scale signals corresponding to a normal image to the pixels 130a of the first pixel set 141 via the data lines D₁-D₃ₘ. At this time, the pixels 130a of the first pixel set 141 are in the first display mode. In addition, when the scan driver 108 outputs scan pulses to scan the second scan line G₂, the data driver 106 outputs black level signals to the pixels 130b of the second pixel set 142 via the data lines D₁-D₃ₘ. At this time, the pixels 130b of the second pixel set 142 are in the second display mode. When the scan driver 108 outputs scan pulses to scan the third scan line G₃ in the i^{th} frame, the data driver 106 outputs gray scale signals corresponding to a normal image to the pixels 130c of the first pixel set 141 via the data lines D₁-D₃ₘ. At this time, the pixels 130c of the first pixel set 141 are in the first display mode. In addition, when the scan driver 108 outputs scan pulses to scan the fourth scan line G₄, the data driver 106 outputs black level signals to the pixels 130d of the second pixel set 142 via the data lines D₁-D₃ₘ. At this time, the pixels 130d of the second pixel set 142 are in the second display mode. The data driver 106 alternatively outputs the gray scale signals corresponding to a normal image and the black level signals until all the scan lines in the i^{th} frame are completely scanned.

When the scan driver 108 outputs scan pulses to scan the first scan line G₁ in the (i+1)^{th} frame, the data driver 106 outputs black level signals to the pixels 130a of the first pixel set 141 via the data lines D₁-D₃ₘ. At this time, the pixels 130a of the first pixel set 141 are in the second display mode. In addition, when the scan driver 108 outputs scan pulses to scan the second scan line G₂, the data driver 106 outputs a gray scale signals corresponding to a normal image to the pixels 130b of the second pixel set 142 via the data lines D₁-D₃ₘ. At this time, the pixels 130b of the second pixel set 142 are in the first display mode. When the scan driver 108 outputs scan pulses to scan the third scan line G₃ in the (i+1)^{th} frame, the data driver 106 outputs black level signals to the pixels 130c of the first pixel set 141 via the data lines D₁-D₃ₘ. At this time, the pixels 130c of the first pixel set 141 are in the second display mode. In addition, when the scan driver 108 outputs scan pulses to scan the fourth scan line G₄, the data driver 106 outputs gray scale signals corresponding to a normal image to the pixels 130d of the second pixel set 142 via the data lines D₁-D₃ₘ. At this time, the pixels 130d of the second pixel set 142 are in the first display mode. The data driver 106 alternatively outputs the black level signals and the gray scale signals corresponding to a normal image until all the scan lines in the (i+1)^{th} frame are completely scanned.

Human version is much sensitive to the brightness. Therefore, human version can sense the gray scales corresponding to the normal image instead of the black level. In an embodiment, if a certain gray scale of an image should be displayed, for example, it is assumed that the gray scale value of the image is B, two adjacent pixels 130a and 130b respectively belong to the first pixel set 141 and the second pixel set 142. In this situation, when the scan lines in the i^{th} frame are scanned, the pixels 130a are in the first display mode, and the gray scale value of the pixels 130a is A, the pixels 130b are in the second display mode, the gray scale value of the pixels 130b is 0, that is, the pixels 130b are written into black level signals. Human version only senses the brightness of the pixels 130a.

Furthermore, when the scan lines in the (i+1)^{th} frame are scanned, the gray scale value of the pixels 130a is changed from A (previously displayed in the i^{th} frame) to 0. That is, the pixels 130a switch from the first display mode (displaying a gray scale corresponding to the normal image) to the second gray mode (displaying a black level). The gray scale value of the pixels 130b changes from 0 (previously displayed in the i^{th} frame) to B. That is, the pixels 130b switch from the second gray mode to the first display mode.

For example, when the gray scale value is switched from 255 representing full white (the current image in the i^{th} frame) to 160 representing gray, two adjacent pixels 130a and 130b respectively belong to the first pixel set 141 and the second pixel set 142. When the scan lines in the i^{th} frame are scanned, the pixels 130a are in the first display mode, and the gray scale value of the pixels 130a is 255. The gray scale value of the pixels 130b is 0, and the pixels 130b are in the second display mode. Human version only senses the white. And then, when the scan lines in the (i+1)^{th} frame are scanned, the gray scale value of the pixels 130a is changed from 255 to 0 (from white to black). The gray scale value of the pixels 130b is changed from 0 to 160. In addition, two adjacent pixels 130c and 130d, which are adjacent to the above-mentioned pixels 130a and 130b, also respectively belong to the first pixel set 141 and the second pixel set 142. When the scan lines in the i^{th} frame are scanned, if the pixels 130c and 130d both display a black level (the gray scale value is 0). Human version senses the black. when the gray scale value is changed from 0 to 160, when the scan lines in the (i+1)^{th} frame are scanned, the pixels 130c are still black (the gray scale value is 0) and the gray scale value of the pixel 130d is changed from 0 to 160.

In this way, the gray scales of the image displayed by the two adjacent pixels 130a and 130b are changed from white to gray. At the same time, the gray scales of the image displayed by the two adjacent pixels 130c and 130d are changed from black to gray. The actual difference of the gray scales between them is about 4%. In other words, the LCD device in present invention can have a smaller gray scale difference without modifying the frame rate when the pixels are changed from different gray scales to the same gray scale.

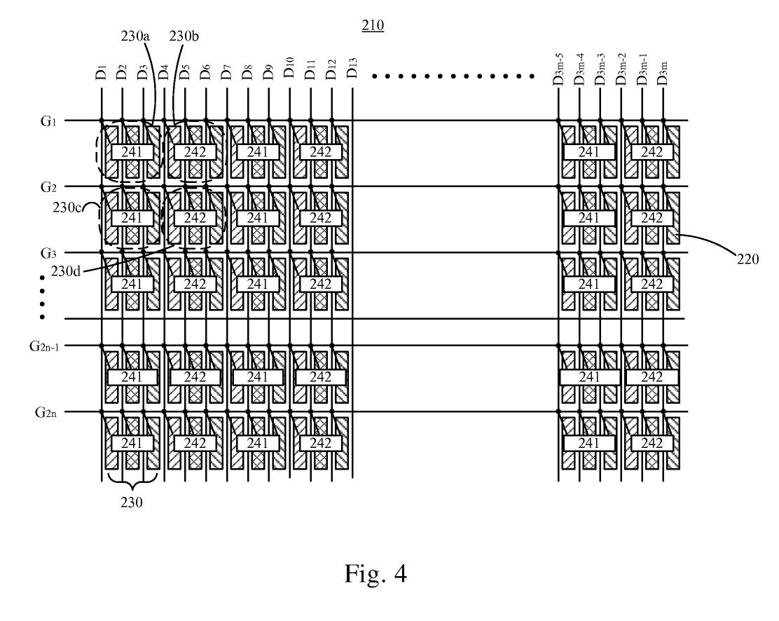

Referring to Fig.4, which is a schematic view illustrating an LCD panel according to the second embodiment of the present invention. The TFTs and the pixel electrodes of the sub-pixels are not shown in the following figures so as to simply the drawings. The sub-pixels 220 shown in Fig.4 are respectively connected to corresponding scan lines G₁-G₂ₙ and data lines D₁-D₃ₘ. It means that the gate and the source of the TFTs of the sub-pixels 220 are respectively connected to the corresponding scan lines G₁-G₂ₙ and data lines D₁-D₃ₘ. The data lines D₁-D₃ₘ comprise a first data line set, such as D₁⁻D₃ . . . D₃ₘ₋₅-D₃ₘ₋₃ and a second data line set such as D₄-D₆ . . .D₃ₘ₋₂-D₃ₘ. That is, the first data line set is adjacent to the second data line set, and the first data line set and the second data line set are alternatively arranged each other. Each of the pixels 230 comprises R, G, B sub-pixels 220. The pixels 230 of the LCD panel 210 are divided to the first pixel set 241 and the second pixel set 242. For example, the sources of the TFTs of pixels 230a and 230c of the first pixel set 241 are coupled to the data lines D₁-D₃ of the first data line set, and the sources of the TFTs of pixels 230b and 230d of the second pixel set 242 are coupled to the data lines D₄-D₆ of the second data line set. That is, in the matrix of the pixels, the pixels in the same column belong to the same pixel set, and pixels in any two adjacent columns respectively belong to different pixel sets.

When the scan pulses are output to scan the scan lines in the i^{th} frame, the gray scale signals corresponding to the normal image are output to the pixels of the first pixel set 241 and the black level signals are output to the pixels of the second pixel set 242. When the scan pulses are output to scan the scan lines in the (i+1)^{th} frame, the gray scale signals corresponding to the normal image are output to the pixels of the second pixel set 242 and the black level signals are output to the pixels of the first pixel set 241. Two adjacent pixels 230a and 230b or another two adjacent pixels 230c and 230d display black, and the rest display the gray scales corresponding to the normal image. Human version is much sensitive to the brightness. Therefore, human version can sense the gray scales corresponding to the normal image instead of the black level.

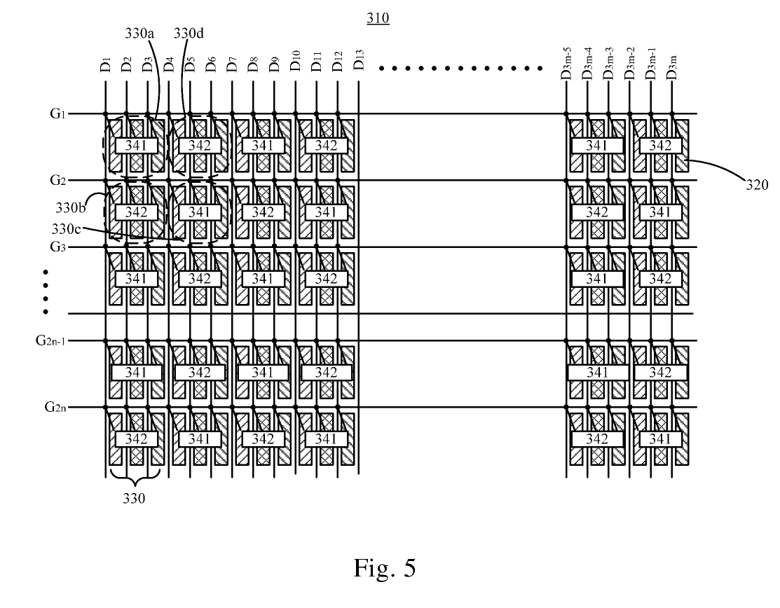

It is similar to the operation of the pixels 130a, 130b, 130c, and 130d shown in FIG. 3, the LCD device in this embodiment reduces the difference of luminance when switching different gray scales to same gray scale in case of remaining the frame rate unchanged. Therefore the display quality of the LCD device is improved. Referring to FIG. 5, which is a schematic view illustrating an LCD device 310 according to the third embodiment of the present invention. The TFTs and the pixel electrodes of the sub-pixels 320 are not shown in the following figures so as to simply the drawings. The sub-pixels 320 shown in FIG. 4 are respectively connected to corresponding scan lines G₁-G₂ₙ and data lines D₁-D₃ₘ. It means that the gate and the source of the TFTs of the sub-pixels 320 are respectively connected to the corresponding scan lines G₁-G₂ₙ and data lines D₁-D₃ₘ. Each of the pixels 330 comprises R, G, B sub-pixels 320. The data lines D₁-D₃ₘ comprise a first data line set, such as D₁-D₃. . . D₃ₘ₋₅-D₃ₘ₋₃ and a second data line set such as D₄-D₆ . . . D₃ₘ₋₂-D₃ₘ. That is, the first data line set is adjacent to the second data line set, and the first data line set and the second data line set are alternatively arranged each other. The pixels 330 of the LCD panel 310 are divided into a first pixel set 341 and a second pixel set 342. For example, the sources of the TFTs of pixel 330a of the first pixel set 341 are coupled to the data lines D₁-D₃ of the first data line set, and the gates of the TFTs of the pixel 330a are coupled to the scan line G₁ of odd scan lines. The sources of the pixel 330c of the first pixel set 341 are coupled to the data lines D₄-D₆ of the second data line set, and the gates of the pixel 330c are coupled to the scan line G₂ of the even scan lines. The sources of the pixel 330b of the second pixel set 342 are coupled to the data lines D₁-D₃ of the first data line set, and the gates of the TFTs of the pixel 330b are coupled to the scan line G₂ of even scan lines. The sources of the pixel 330d of the second pixel set 342 are coupled to the data lines D₄-D₆ of the second data line set, and the gates of the pixel 330d are coupled to the scan line G₁ of the odd scan lines. That is, in the matrix of the pixels, any two adjacent pixels 320 respectively belong to the first pixel set 341 and the second pixel set 342.

When the scan pulses are output to scan the scan lines in the i^{th} frame, the gray scale signals corresponding to the normal image are output to the pixels of the first pixel set 341 and the black level signals are output to the pixels of the second pixel set 342. When the scan pulses are output to scan the scan lines in the (i+1)^{th} frame, the gray scale signals corresponding to the normal image are output to the pixels of the second pixel set 342 and the black level signals are output to the pixels of the first pixel set 341. Human version is much sensitive to the brightness. Therefore, human version can sense the gray scales corresponding to the normal image instead of the black level.

It is similar to the operation of the pixels 130a, 130b, 130c, and 130d shown in FIG. 3, when the gray scales of the pixels 330a and 330b are changed from white to gray and the gray scales of the pixels 330c and 330d are changed from black to gray, the brightness difference of the LCD device can have only about 4%. The LCD device in this embodiment reduces the difference of luminance when switching different gray scales to same gray scale in case of remaining the frame rate unchanged. Therefore the display quality of the LCD device is improved.

In the following disclosure, the present invention further provides a driving method of the LCD device. The driving method comprises:

Step(A): when the scan lines in the i^{th} frame are scanned, the data driver outputs gray scale voltage signals corresponding to a normal image to the pixels of the first pixel set via the data lines, and outputs specific gray scale voltage signals to the pixels of the second pixel set;

Step(B): when the scan lines in the (i+1)^{th} frame are scanned, the data driver outputs specific gray scale voltage signals to the pixels of the first pixel set, and outputs gray voltage signals corresponding to a normal image to the pixels of the second pixel set;

Step(C): repeating the step (A) and step (B), wherein i is a positive integer.

In contrast to the prior art, the LCD device and related driving method thereof in this present invention reduce the difference of luminance when switching different gray scales to same gray scale in case of remaining the frame rate unchanged.

Therefore the display quality of the LCD device is improved. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An LCD device, comprising:
an LCD panel, comprising:
a plurality of scan lines;
a plurality of data lines intersecting the scan lines;
a plurality of pixels arranged in a matrix form, each pixel including a plurality of sub-pixels, each of the sub-pixels disposed in an area defined by the scan lines and the data lines;
scan drivers applying scan pulses to the scan lines; and
data drivers applying gray scale voltage signals to the data lines; characterized in that:
the pixels are divided into a first pixel set and a second pixel set, pixels of the first pixel set and pixels of the second pixel set are arranged alternatively;
in the pixels arranged in the matrix form, two adjacent pixels respectively are divided into the first pixel set and the second pixel set, each of the pixels has a first display mode and a second display mode, in the first display mode, the data drivers apply gray scale voltage signals corresponding to a normal image to the pixels via the data lines, in the second display mode, the data drivers apply black level signals to the pixels via the data lines; wherein the pixels of the first pixel set and the pixels of the second pixel set are alternatively switched between the first display mode and the second display mode with switching from one frame to the next frame.

2. The LCD device of claim 1, characterized in that:
when the scan lines in the i^{th} frame are scanned, the pixels in one of the first pixel set and the second pixel set are in the first display mode, and the pixels in the other of the first pixel set and the second pixel set are in the second display mode;
when the scan lines in the (i+1)^{th} frame are scanned, the pixel set in the first display mode in the i^{th} frame is switched to the second display mode, and the pixel set in the second display mode in the i^{th} frame is switched to the first display mode, wherein i is a positive integer.

3. The LCD device of claim 1, characterized in that:
each of the pixels comprises at least red sub-pixels, green sub-pixels, and blue sub-pixels.

4. An LCD device, comprising:
an LCD panel, comprising:
a plurality of scan lines;
a plurality of data lines intersecting the scan lines;
a plurality of pixels arranged in a matrix form, each pixel including a plurality of sub-pixels, each of the sub-pixels disposed in an area defined by the scan lines and the data lines;
scan drivers applying scan pulses to the scan lines; and
data drivers applying gray scale voltage signals to the data lines;
characterized in that:
the pixels are divided into a first pixel set and a second pixel set, pixels of the first pixel set and pixels of the second pixel set are arranged alternatively;
in the pixels arranged in the matrix form, two adjacent pixels respectively are divided into the first pixel set and the second pixel set, each of the pixels has a first display mode and a second display mode, in the first display mode, the data drivers apply gray scale voltage signals corresponding to a normal image to the pixels via the data lines, in the second display mode, the data drivers apply specific gray scale voltage signals to the pixels via the data lines; wherein the pixels of the first pixel set and the pixels of the second pixel set are alternatively switched between the first display mode and the second display mode with switching from one frame to the next frame.

5. The LCD device of claim 4, characterized in that:
when the scan lines in the i^{th} frame are scanned, the pixels in one of the first pixel set and the second pixel set are in the first display mode, and the pixels in the other of the first pixel set and the second pixel set are in the second display mode;
when the scan lines in the (i+1)^{th} frame are scanned, the pixel set in the first display mode in the i^{th} frame is switched to the second display mode, and the pixel set in the second display mode in the i^{th} frame is switched to the first display mode, wherein i is a positive integer.

6. The LCD device of claim 4, characterized in that:
in the matrix of the pixels, the pixels in each row belong to the same pixel set, and pixels in any two adjacent row respectively belong to different pixel sets.

7. The LCD device of claim 4, characterized in that:
in the matrix of the pixels, the pixels in each column belong to the same pixel set, and pixels in any two adjacent columns respectively belong to different pixel sets.

8. The LCD device of claim 7, characterized in that:
the specific gray scale voltage signals are black level signals.

9. The LCD device of claim 4, characterized in that:
each of the pixels comprises at least red sub-pixels, green sub-pixels, and blue sub-pixels.

10. A driving method of an LCD device, the LCD device comprising an LCD panel including a plurality of scan lines, a plurality of data lines intersecting the scan lines, and a plurality of pixels arranged in a matrix form, each pixel including a plurality of sub-pixels, each of the sub-pixels disposed in an area defined by the scan lines and the data lines; scan drivers applying scan pulses to the scan lines; and data drivers applying gray scale voltage signals to the data lines; the pixels are divided into a first pixel set and a second pixel set, pixels of the first pixel set and pixels of the second pixel set are arranged alternatively; characterized in that: the driving method comprises:
(A) when the scan lines in the i^{th} frame are scanned, the data driver outputs gray scale voltage signals corresponding to a normal image to the pixels of the first pixel set via the data lines, and outputs specific gray scale voltage signals to the pixels of the second pixel set;
(B) when the scan lines in the (i+1)^{th} frame are scanned, the data driver outputs specific gray scale voltage signals to the pixels of the first pixel set, and outputs gray voltage signals corresponding to a normal image to the pixels of the second pixel set;
(C) repeating the step (A) and step (B), wherein i is a positive integer.

11. The driving method of claim 10, characterized in that:
in the matrix of the pixels, the pixels in each row belong to the same pixel set, and pixels in any two adjacent row respectively belong to different pixel sets.

12. driving method of claim 10, characterized in that:
in the matrix of the pixels, the pixels in each column belong to the same pixel set, and pixels in any two adjacent columns respectively belong to different pixel sets.

13. The driving method of claim 10, characterized in that:
in the matrix of the pixels, any two adjacent pixels respectively belong to different pixel sets.

14. The driving method of claim 10, characterized in that:
the specific gray scale voltage signals are black level signals.

15. The driving method of claim 10, characterized in that:
each of the pixels comprises at least red sub-pixels, green sub-pixels, and blue sub-pixels.
